(19) United States
(12) Patent Application Publication
(10) Pub. No.: US 2018/0287804 A1
(43) Pub. Date: Oct. 4, 2018

(54) RESILIENT PUBLIC KEY INFRASTRUCTURE FOR CLOUD COMPUTING

(71) Applicant: Microsoft Technology Licensing, LLC, Redmond, WA (US)

(72) Inventor: Christopher Jon GEISBUSH, Sammamish, WA (US)

(73) Assignee: Microsoft Technology Licensing, LLC, Redmond, WA (US)

(21) Appl. No.: 15/477,513

(22) Filed: Apr. 3, 2017

(51) Int. Cl. H04L 9/32; H04L 29/06

(52) U.S. Cl. CPC H04L 9/3268; H04L 63/0442; H04L 63/10; H04L 63/0823

(57) ABSTRACT

A certificate management system for a cloud network including resource instances includes a certificate management application that is stored in memory and executed by a processor and that is configured to selectively assign first certificates from a first root certificate authority and second certificates from a second root certificate authority that is independent from the first root certificate authority to resource instances in the cloud network. In response to revocation of the first certificates from the first root certificate authority, the certificate management application is configured to replace the first certificates from the first root certificate authority from the resource instances in the cloud network with the second certificates from the second root certificate authority in the resource instances in the cloud network.

### FIELD

The present disclosure relates to cloud networks, and more particularly to public key infrastructure in cloud networks.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Cloud service providers support many different types of services including cloud storage, infrastructure as a service (IaaS), internet of things (IoT), platform as a service (PaaS), etc. The different services are supported in a cloud network using different cloud resources. In some examples, the resources are implemented by virtual machine (VM) and/or container instances. Container instances may include one or more software modules and libraries and require the use of some portions of an operating system and hardware.

To ensure security within and outside of the cloud network, a public key infrastructure (PKI) may be used to create, manage, distribute, use, store, and revoke digital certificates and manage public-key encryption for each of the resources. PKI facilitates secure electronic transfer of information and is used when passwords are an inadequate authentication method.

PKI is a form of cryptography that binds public keys with respective identities of entities (like persons and organizations) with a computing resource. The binding is established through a process of registration and issuance of certificates by a certificate authority (CA). When a root CA is compromised, all of the certificates in the chain of the root CA need to be replaced or rolled over. Rolling all of the certificates in a cloud scale environment is a slow, error-prone process. Given the slow rollover process, the tenants are forced to either shut down the corresponding resource or risk exposure of data to attacks until the compromised root CA can be replaced.

### SUMMARY

A certificate management system for a cloud network including resource instances comprises a certificate management application that is stored in memory and executed by a processor and that is configured to selectively assign first certificates from a first root certificate authority and second certificates from a second root certificate authority that is independent from the first root certificate authority to resource instances in the cloud network. In response to revocation of the first certificates from the first root certificate authority, the certificate management application is configured to replace the first certificates from the first root certificate authority from the resource instances in the cloud network with the second certificates from the second root certificate authority in the resource instances in the cloud network.

In other features, the certificate management application is technically constrained to assign the first root certificates and the second root certificates to the resources instances of the cloud network. The certificate management application is configured to communicate with the first root certificate authority and the second root certificate authority using an offline connection.

In other features, the certificate management application is configured to detect revocation of the first root certificate authority. The certificate management application is configured to detect revocation of the first root certificate authority by communicating with an online certificate status protocol (OCSP) server.

In other features, the certificate management application is configured to detect revocation of the first root certificate authority by communicating with a certificate revocation list (CRL) server. The certificate management application is configured to detect revocation of the first root certificate authority by communicating with a certificate trust server.

In other features, the certificate management application is configured replace the first certificates from the first root certificate authority in first ones of the resource instances in the cloud network with the second certificates from the second root certificate authority using a push approach. The certificate management application is configured replace the first certificates from the first root certificate authority in second ones of the resource instances in the cloud network with the second certificates from the second root certificate authority using a pull approach.

In other features, the certificate management application is configured use a self-signed certificate when replacing the first root certificates of the resource instances in the cloud network with the second certificates from the second root certificate authority.

A certificate management system for a cloud network including resource instances includes a certificate assignment module configured to selectively assign first certificates from a first root certificate authority and second certificates from a second root certificate authority that is independent from the first root certificate authority to resource instances in the cloud network. A certificate revocation module is configured to determine whether certificates issued by the first root certificate authority are revoked. In response to the revocation, the certificate assignment module is further configured to remove the first root certificates of the resource instances in the cloud network and install the second certificates from the second root certificate authority in the resource instances in the cloud network.

In other features, the certificate assignment module is technically constrained to assign the first root certificates and the second root certificates in a domain corresponding to a domain of the resources instances of the cloud network.

In other features, the certificate assignment module communicates with the first root certificate authority and the second root certificate authority using an offline connection. The certificate revocation module is configured to detect revocation of the first root certificate authority by communicating with an online certificate status protocol (OCSP) server. The certificate revocation module is configured to detect revocation of the first root certificate authority by communicating with a certificate revocation list (CRL) server.

In other features, the certificate revocation module is configured to detect revocation of the first root certificate authority by communicating with a certificate trust server. The certificate assignment module is configured replace the first certificates from the first root certificate authority in first ones of the resource instances in the cloud network with the second certificates from the second root certificate authority using a push approach. The certificate assignment module is configured replace the first certificates from the first root certificate authority in second ones of the resource instances in the cloud network with the second certificates from the second root certificate authority using a pull approach.

In other features, a security module is configured to cause the certificate assignment module to use a self-signed certificate when replacing the first root certificates of the resource instances in the cloud network with the second certificates from the second root certificate authority.

A method for managing certificates in a cloud network including resource instances includes selectively assigning first certificates from a first root certificate authority and second certificates from a second root certificate authority that is independent from the first root certificate authority to resource instances in the cloud network. In response to a certificate revocation, the method includes removing the first root certificates from the resource instances in the cloud network and installing the second certificates from the second root certificate authority in the resource instances in the cloud network.

In other features, the first root certificates and the second root certificates are technically constrained to a domain corresponding to a domain of the resources instances of the cloud network. The method includes detecting revocation of the first root certificate authority by communicating with at least one of certificate revocation list (CRL) server, a certificate trust server and an online certificate status protocol (OCSP) server.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF DRAWINGS

FIG. 1A is a functional block diagram of an example of a certificate management system according to the present disclosure.

FIG. 1B is a functional block diagram of another example of a certificate management system according to the present disclosure.

FIGS. 2A and 2B are functional block diagrams of examples of virtual machine resources instances in the cloud network that may require certificates to be managed;

FIG. 3 is a functional block diagram of an example of a subordinate certificate authority server;

FIG. 4 is a flowchart illustrating an example of a method for operating the subordinate certificate authority server;

FIG. 5 is a flowchart illustrating another example of a method for operating the subordinate certificate authority server; and

FIG. 6 is a flowchart illustrating an example of a method for selecting between a push and a pull method for updating certificates.

In the drawings, reference numbers may be reused to identify similar and/or identical elements.

### DESCRIPTION

The present disclosure relates to a resilient PKI for a cloud network that relies upon certificates supplied by two or more external root certificate authorities (CAs). The present disclosure also relates to a cloud network infrastructure to support automated certificate management and certificate pinning. The systems and methods described herein can be used to replace the certificates issued by the root CA in a cloud network when the root CA is compromised.

If a first root CA is compromised, the systems and methods described herein remove the certificates based on the first root CA and deploy certificates based on a second root CA to automatically replace the compromised certificate chain. The first certificates from the first root CA can be simply replaced with the second certificates from the second root CA (with or without deleting the first certificates) or the first certificates can be removed (e.g. deleted) and then replaced by the second certificates. Once installed, the second certificates from the second root CA are used to secure communication.

The certificates from the first and second root CAs can be directly assigned by first and second root CAs or a subordinate server in the cloud network can be granted permission to issue certificates based on the first and second root CAs. Currently, a breach in the first CA chain would render the cloud network wide open to attacks from malicious users leveraging what would appear to be valid certificates.

If the first CA is compromised, all of the certificates in the corresponding certificate chain can no longer be trusted until they are replaced. During the intervening period, an attacker can access network data using the compromised first root CA. On a cloud scale, normally it takes on the order of a month or two to remove the first root CA and install certificates based on the second root CA. The systems and methods described below can deploy certificates based on the second root CA (distinct from the first root CA chain) to enable immediate failover once a breach is detected.

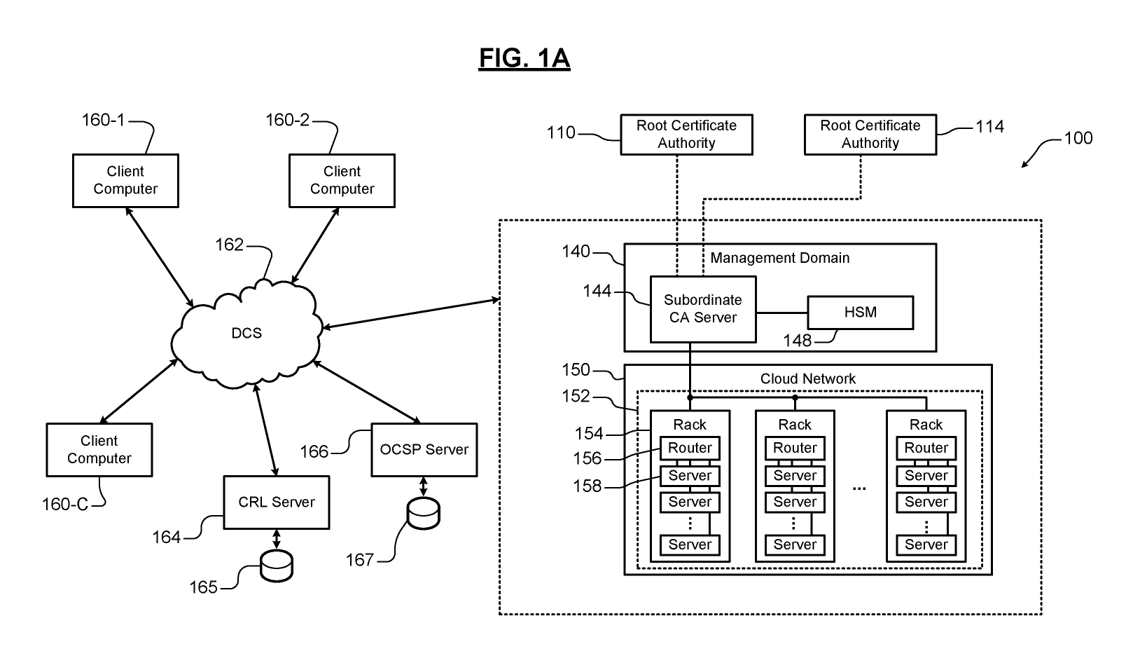

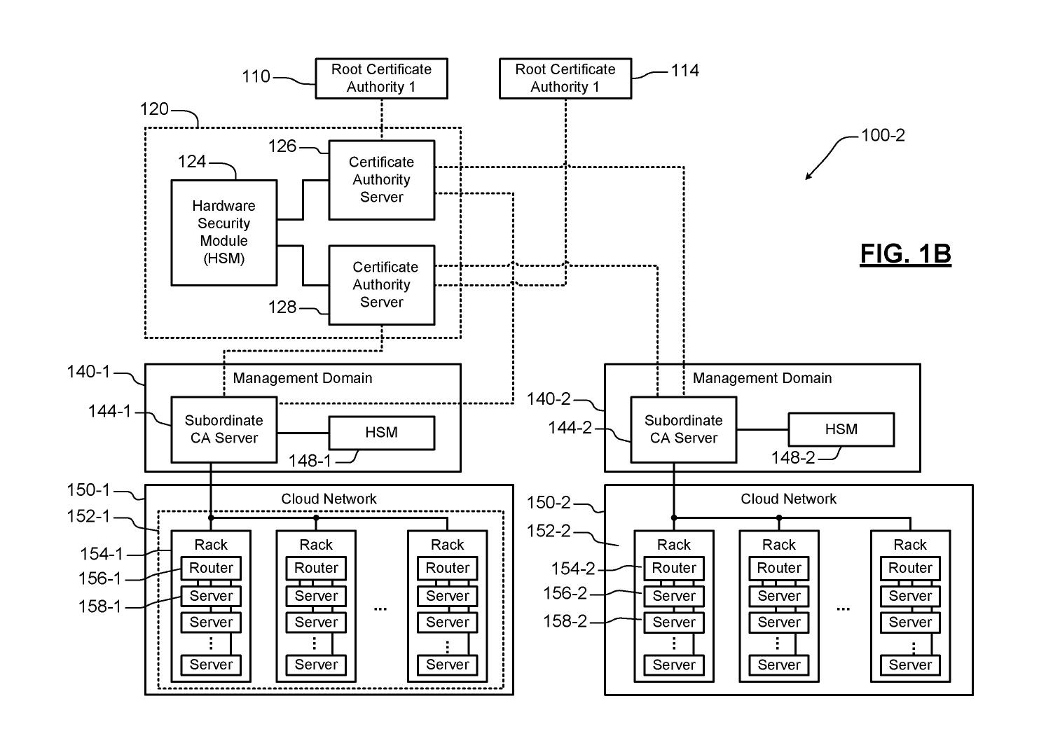

Referring now to FIG. 1A, an example of a cloud services provider 100 is shown. The cloud services provider 100 is associated with two or more root certificate authorities 110 and 114. In this example, the two or more root certificate authorities 110 and 114 are independent of one another. The cloud services provider 100 further includes a management domain 140 including a subordinate certificate authority (CA) server 144 and a hardware security module (HSM) 148.

The subordinate CA server 144 manages certificates from the two or more root certificate authorities 110 and 114. In some examples, the ability of the subordinate CA server 144 to issue certificates may be technically constrained to the domain of the cloud network, which means that the subordinate CA server 144 cannot issue certificates to resource instances located in other domains. The subordinate CA server 144 manages certificate pinning as needed for a cloud network 150. The HSM 148 safeguards and manages digital keys for strong authentication and provides cryptoprocessing. In some examples, the HSM 148 includes a plug-in card or an external server or device that attaches directly to the subordinate CA server 144.

The cloud network 150 includes one or more clusters 152. Each of the clusters 152 includes one or more racks 154. Each of the racks 154 includes a router 156 and one or more servers 158. The servers 158 support the resource instances of the cloud network 150.

In some examples, the resources that are protected by the PKI infrastructure described herein are implemented by virtual machine (VM) and/or container instances. The VM and container instances can be implemented by the servers 158. In other examples, the resources that are protected by the PKI infrastructure described herein can be logical resources that do not physically map directly to a particular server in the cloud network. In some examples, the root certificate authorities 110 and 114 are connected by off-line connections to the management domain 140 as shown by dotted lines in FIG. 1A. More particularly, the root CA may provide a signing certificate to the subordinate CA. The signing certificate can be used to authorize and sign certificates on behalf of the root. The signing certificates may be downloaded and installed manually (e.g. off-line).

The cloud services provider 100 communicates with one or more client computers 160-1, 160-2, . . . 160-C (where C is an integer greater than 1) (collectively client computers 160 via a distributed communications system 162 such as the Internet. The client computers 160 can be part of an on-premises enterprise network, stand-alone computers, etc. The cloud services provider 100 may also communicate with a certificate revocation list (CRL) server 164 that manages a CRL list store 165 including lists of certificates that have been revoked. The cloud services provider 100 may download or crawl the CRL list to identify revoked certificates as will be described further below. Alternately, the cloud services provider 100 may also communicate with an online certificate status protocol (OCSP) server 166 that manages an OCSP list store 167. The cloud services provider 100 may send requests relating to one or more certificates to the OCSP server 166 and receive responses to identify revoked certificates as will be described further below. In some examples, the requests are sent on a periodic or event basis. In other examples, certificate revocation can be manually initiated or reliance can be placed on a trust store such as Windows Trust Store.

Referring now to FIG. 1B, another example of the cloud services provider 100 is shown. The cloud services provider 100 is also associated with two or more root certificate authorities (CAs) 110 and 114. In this example, the two or more root certificate authorities 110 and 114 are independent of one another.

The cloud services provider 100 includes certificate authority servers 126 and 128 that communicate with the two or more root certificate authorities 110 and 114. The certificate authority servers 126 and 128 communicate with a hardware security module (HSM) 124. In some examples, the root certificate authorities 110 and 114 are connected by off-line connections to the certificate authority servers 126 and 128 as shown by dotted lines in FIG. 1B.

The cloud services provider 100 further includes first and second management domains 140-1 and 140-2 including first and second subordinate certificate authority (CA) servers 144-1 and 144-2 and first and second hardware security modules (HSMs) 148-1 and 148-2, respectively. In some examples, the subordinate CA servers 144-1 and 144-2 are technically constrained to their respective domains.

The certificate authority servers 126 and 128 and the first and second subordinate CA servers 144-1 and 144-2 manage the certificates from the two or more root certificate authorities 110 and 114 for corresponding cloud networks 150-1 and 150-2. The first and second subordinate CA servers 144-1 and 144-2 manage certificate pinning as needed. In some examples, the certificate authority servers 126 and 128 are in different domains with respect to the first and second subordinate CA servers 144-1 and 144-2.

The cloud networks 150-1 and 150-2 each include one or more clusters 152. Each of the clusters 152 includes one or more racks 154. Each of the racks includes a router 156 and one or more servers 158. The resource instances of the cloud networks 150-1 and 150-2 are implemented by the servers 158.

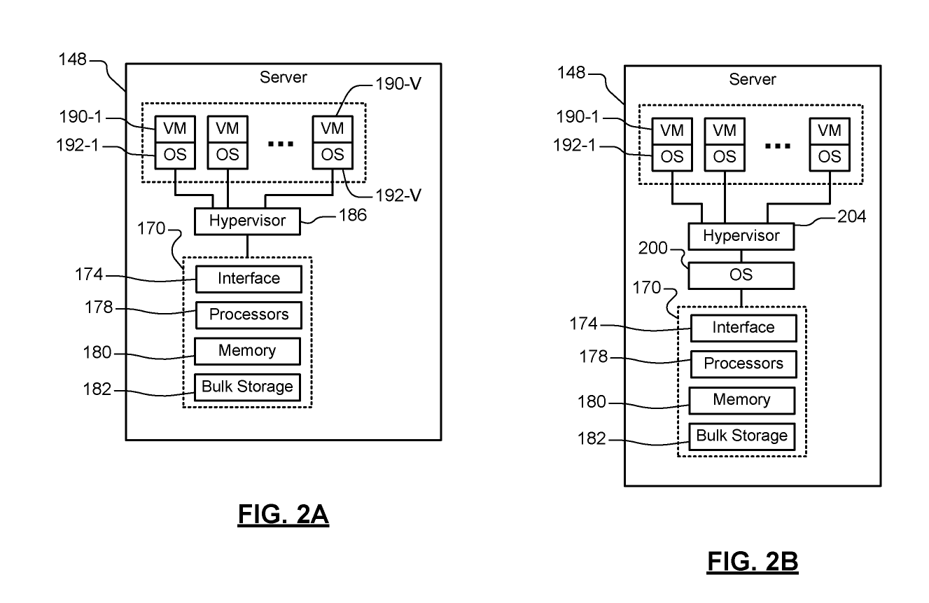

Referring now to FIGS. 2A and 2B, examples of the servers 158 for hosting VM and/or container instances are shown. In FIG. 2A, a server using a native hypervisor is shown. The server 158 includes hardware 170 such as a wired or wireless interface 174, one or more processors 178, volatile and nonvolatile memory 180 and bulk storage 182 such as a hard disk drive or flash drive. A hypervisor 186 runs directly on the hardware 170 to control the hardware 170 and manage virtual machines 190-1, 190-2, . . . , 190-V (collectively virtual machines 190) and corresponding guest operating systems 192-1, 192-2, . . . , 192-V (collectively guest operating systems 192) where V is an integer greater than one.

In this example, the hypervisor 186 runs on a conventional operating system. The guest operating systems 192 run as a process on the host operating system. Examples of the hypervisor include Microsoft Hyper-V, Xen, Oracle VM Server for SPARC, Oracle VM Server for x86, the Citrix XenServer, and VMware ESX/ESXi, although other hypervisors can be used.

Referring now to FIG. 2B, a second type of hypervisor can be used. The server 158 includes hardware 170 such as a wired or wireless interface 174, one or more processors 178, volatile and nonvolatile memory 180 and bulk storage 182 such as a hard disk drive or flash drive. A hypervisor 204 runs on a host operating system 200. Virtual machines 190-1, 190-2, . . . , 190-V (collectively virtual machines 190) and corresponding guest operating systems 192-1, 192-2, . . . , 192-V (collectively guest operating systems 192). The guest operating systems 192 are abstracted from the host operating system 200. Examples of this second type include VMware Workstation, VMware Player, VirtualBox, Parallels Desktop for Mac and QEMU. While two examples of hypervisors are shown, other types of hypervisors can be used.

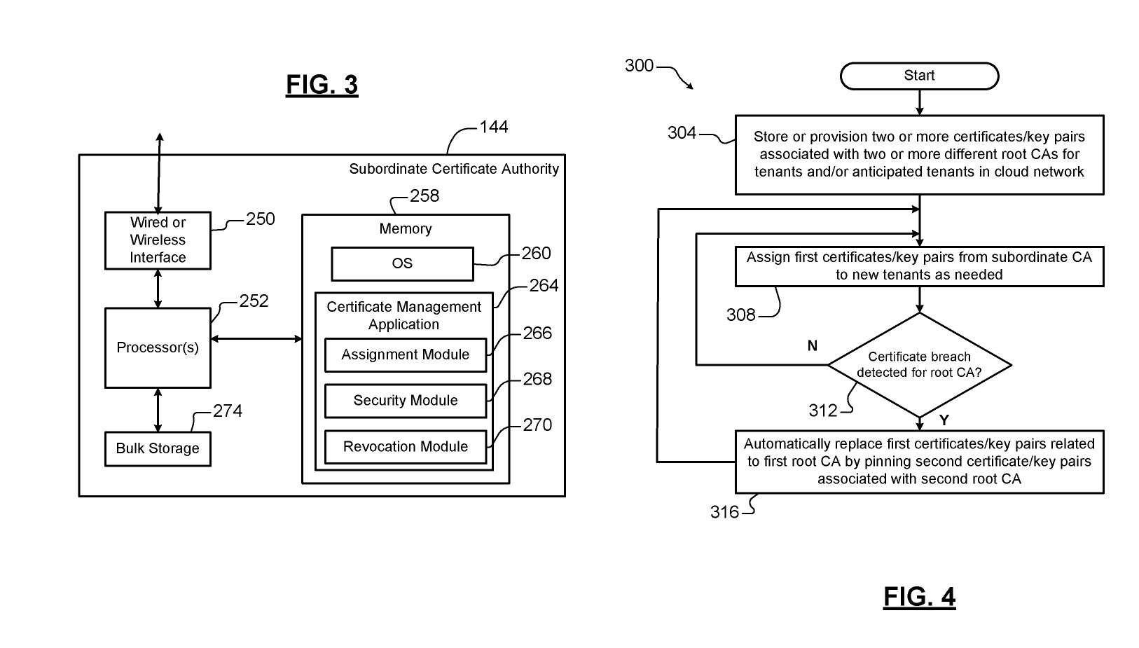

Referring now to FIG. 3, an example of the subordinate CA server 144 is shown to include a wired or wireless interface 250, one or more processors to 52 and memory 258. The memory 258 includes an operating system 260 and a certificate management application 264. The subordinate CA server 144 further includes bulk storage 274 such as a hard disk drive.

The certificate management application 264 includes an assignment module 266 that assigns certificates from the first CA root or the second CA root as needed. The certificate management application 264 includes a security module 268 that ensures security when assigning the certificates to the tenant instance. For example, the security module 268 may use a self-signed certificate when assigning the first certificates/key pair or replacing the first certificate/key pair with the second certificate/key pair. The self-signed certificate may include a key that is assigned to the server offline prior to installation of the server. Once the server signs on, the self-signed certificate/key pair from the first root CA is replaced with the first certificate/key pair from the first root CA. When the first certificate/key pair is revoked, the self-signed certificate may be used again to ensure trusted communication with the tenant instance while the second certificate/key pair from the second root CA is installed.

The certificate management application 264 includes a revocation module 270 that determines when the certificates from the root CA are revoked. The revocation module 270 may monitor the CRL list, send requests and receive responses from the OCSP server, monitor a trust store such as Windows Trust Store and/or manually revoke certificates from the first root CA.

Referring now to FIG. 4, a method 304 for managing certificates by a cloud services provider is shown. At 304, two or more certificates are provisioned or stored for existing or anticipated tenants in a cloud network from two or more independent root certificate authorities (CA). In some examples, the certificates can be issued by a subordinate server and are technically constrained to the domain of the cloud network. In other examples, the certificates are preassigned by the first root CA and the second root CA for each tenant. The certificates and corresponding key pairs are stored in and managed by one or more subordinate CA servers and one or more HSMs.

At 308, first certificates/key pairs associated with a first root CA are assigned by a subordinate CA server to new tenants of the cloud network as needed at 308. For example, the certificates and key pairs may be assigned as new tenant resources are instantiated. If a certificate breach of the first root CA is detected at 312, the subordinate CA server automatically replaces the first certificates associated with the first root CA with second certificates associated with the second root CA at 316.

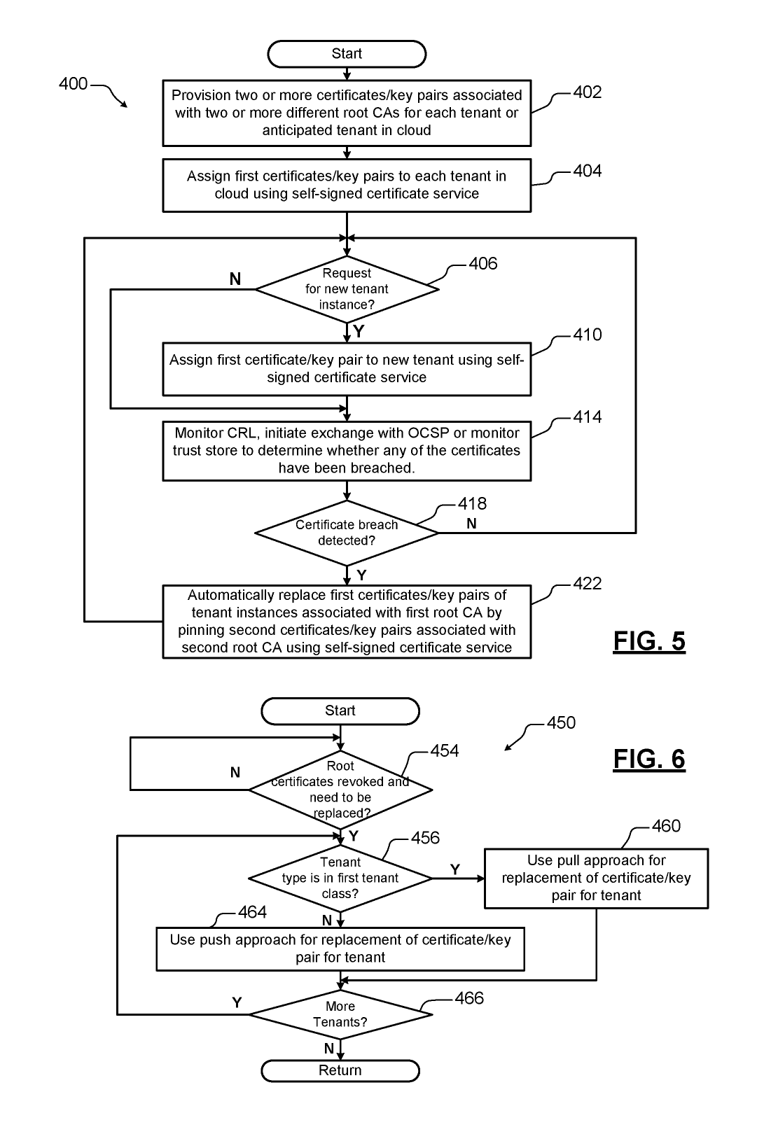

Referring now to FIG. 5, a method 404 for managing certificates by a cloud network is shown. At 402, two or more certificates/key pairs from two or more different root CAs are provisioned or stored for each of the tenants and/or anticipated tenants in the cloud network. At 404, first certificates/key pairs are assigned to each tenant in the cloud network. In some examples, the first certificates/key pairs are assigned using a self-signed certificate service. In some examples, the self-signed certificate service employs public and private keys that are assigned to the server off-line prior to connection to the cloud network.

If there is a request for a new tenant instance at 406, a first certificate/key pair is assigned to the new tenant instance using the self-signed certificate service at 410. At 414, the method monitors a certificate revocation list (CRL) located on a remote CRL server, sends an inquiry to an online certificate status protocol (OCSP) server or monitors a trust store. If the certificates generated by the first root CA are breached or revoked as determined by monitoring the CRL, the trust store, and/or the responses from the OCSP server at 418, the method automatically replaces the first certificates/key pairs for tenant instances associated with the first root CA by pinning a second certificate/key pair associated with a second root CA using the self-signed certificate service.

Referring now to FIG. 6, a method 450 for selecting a push or pull approach when replacing the certificates associated with the first root CA with certificates associated with the second root CA is shown. For example, certain tenants such as VMs may be subject to an update domain constraint. These tenants may be placed in a first tenant class where the replacement of the certificates is performed using a pull approach. In other words, the VMs will update the certificate when the next update is performed. Other tenants such as IaaS, PaaS and/or IoT resources may be in a second class where the replacement of the certificates is performed using a push approach.

At 454, the method determines whether the root certificates have been revoked and need to be replaced. If 454 is true, the method continues at 456 and determines whether the tenant type is in the first tenant class. If 456 is true, the method uses the pull approach for replacing the certificates/key pair for the tenant. If 456 is false, the method uses the push approach for replacement of the certificates/key pair for the tenant. The method continues from 460 and 464 with 466. At 466, the method determines whether there are additional tenants that require certificates to be replaced. If 466 is true, the method continues at 456.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

In this application, apparatus elements described as having particular attributes or performing particular operations are specifically configured to have those particular attributes and perform those particular operations. Specifically, a description of an element to perform an action means that the element is configured to perform the action. The configuration of an element may include programming of the element, such as by encoding instructions on a non-transitory, tangible computer-readable medium associated with the element.

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as JavaScript Object Notation (JSON), hypertext markup language (HTML) or extensible markup language (XML), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

None of the elements recited in the claims are intended to be a means-plus-function element within the meaning of 35 U.S.C. §112(f) unless an element is expressly recited using the phrase “means for,” or in the case of a method claim using the phrases “operation for” or “step for.”

What is claimed is:

1. A certificate management system for a cloud network including resource instances, comprising:
a processor;
memory;
a certificate management application that is stored in the memory and executed by the processor and that is configured to:
selectively assign first certificates from a first root certificate authority and second certificates from a second root certificate authority that is independent from the first root certificate authority to resource instances in the cloud network; and
in response to revocation of the first certificates from the first root certificate authority, replace the first certificates from the first root certificate authority from the resource instances in the cloud network with the second certificates from the second root certificate authority in the resource instances in the cloud network.

2. The certificate management system of claim 1, wherein the certificate management application is technically constrained to assign the first root certificates and the second root certificates for the resources instances of the cloud network.

3. The certificate management system of claim 1, wherein the certificate management application is configured to communicate with the first root certificate authority and the second root certificate authority using an offline connection.

4. The certificate management system of claim 1, wherein the certificate management application is configured to detect revocation of the first root certificate authority.

5. The certificate management system of claim 4, wherein the certificate management application is configured to detect revocation of the first root certificate authority by communicating with an online certificate status protocol (OCSP) server.

6. The certificate management system of claim 4, wherein the certificate management application is configured to detect revocation of the first root certificate authority by communicating with a certificate revocation list (CRL) server.

7. The certificate management system of claim 4, wherein the certificate management application is configured to detect revocation of the first root certificate authority by communicating with a certificate trust server.

8. The certificate management system of claim 1, wherein:
the certificate management application is configured replace the first certificates from the first root certificate authority in first ones of the resource instances in the cloud network with the second certificates from the second root certificate authority using a push approach; and
the certificate management application is configured replace the first certificates from the first root certificate authority in second ones of the resource instances in the cloud network with the second certificates from the second root certificate authority using a pull approach.

9. The certificate management system of claim 1, wherein the certificate management application is configured use a self-signed certificate when replacing the first root certificates of the resource instances in the cloud network with the second certificates from the second root certificate authority.

10. A certificate management system for a cloud network including resource instances, comprising:
a certificate assignment module configured to selectively assign first certificates from a first root certificate authority and second certificates from a second root certificate authority that is independent from the first root certificate authority to resource instances in the cloud network; and
a certificate revocation module configured to determine whether certificates issued by the first root certificate authority are revoked,
wherein in response to the revocation, the certificate assignment module is further configured to:
remove the first root certificates of the resource instances in the cloud network; and
install the second certificates from the second root certificate authority in the resource instances in the cloud network.

11. The certificate management system of claim 10, wherein the certificate assignment module is technically constrained to assign the first root certificates and the second root certificates in a domain corresponding to a domain of the resources instances of the cloud network.

12. The certificate management system of claim 10, wherein the certificate assignment module communicates with the first root certificate authority and the second root certificate authority using an offline connection.

13. The certificate management system of claim 10, wherein the certificate revocation module is configured to detect revocation of the first root certificate authority by communicating with an online certificate status protocol (OCSP) server.

14. The certificate management system of claim 10, wherein the certificate revocation module is configured to detect revocation of the first root certificate authority by communicating with a certificate revocation list (CRL) server.

15. The certificate management system of claim 10, wherein the certificate revocation module is configured to detect revocation of the first root certificate authority by communicating with a certificate trust server.

16. The certificate management system of claim 10, wherein:
the certificate assignment module is configured replace the first certificates from the first root certificate authority in first ones of the resource instances in the cloud network with the second certificates from the second root certificate authority using a push approach; and
the certificate assignment module is configured replace the first certificates from the first root certificate authority in second ones of the resource instances in the cloud network with the second certificates from the second root certificate authority using a pull approach.

17. The certificate management system of claim 10, further comprising a security module configured to cause the certificate assignment module to use a self-signed certificate when replacing the first root certificates of the resource instances in the cloud network with the second certificates from the second root certificate authority.

18. A method for managing certificates in a cloud network including resource instances, comprising:
selectively assigning first certificates from a first root certificate authority and second certificates from a second root certificate authority that is independent from the first root certificate authority to resource instances in the cloud network; and
in response to a certificate revocation:
removing the first root certificates from the resource instances in the cloud network; and
installing the second certificates from the second root certificate authority in the resource instances in the cloud network.

19. The method of claim 18, wherein the first root certificates and the second root certificates are technically constrained to a domain corresponding to a domain of the resources instances of the cloud network.

20. The method of claim 18, further comprising detecting revocation of the first root certificate authority by communicating with at least one of certificate revocation list (CRL) server, a certificate trust server and an online certificate status protocol (OCSP) server.
